(19) United States
(12) Patent Application Publication
(10) Pub. No.: US 2025/0200440 A1
(43) Pub. Date: Jun. 19, 2025

(54) Aligning Sequence Processing Models with Recommendation Knowledge

(71) Applicant: Google LLC, Mountain View, CA (US)

(72) Inventors: Maheswaran Sathiamoorthy, Santa Clara, CA (US); Nikhil Mehta, San Jose, CA (US); Xinyang Yi, Mountain View, CA (US); Yuwei Cao, Mountain View, CA (US); Raghunandan Hulikal Keshavan, Santa Clara, CA (US); Lichan Hong, Los Altos, CA (US); Lukasz Andrzej Heldt, Fremont, CA (US); Ed Huai-hsin Chi, Los Altos Hills, CA (US)

(21) Appl. No.: 18/981,061

(22) Filed: Dec. 13, 2024

Related U.S. Application Data
(60) Provisional application No. 63/610,866, filed on Dec. 15, 2023.

(51) Int. Cl. G06N 20/00

(52) U.S. Cl. CPC G06N 20/00

(57) ABSTRACT

The present disclosure provides systems and methods that align sequence processing models with recommendation knowledge. Example training systems can generate natural language prompts, which can be referred to as ‘auxiliary prompts’, that encode different types of recommendation-related knowledge, such as item attributes and user preferences. These auxiliary prompts encode into natural language format various operations and losses that can be used to impart recommendation knowledge to a sequence processing model, including item embedding, Bayesian personalized ranking (BPR), and masked item modeling.

### RELATED APPLICATION

This application claims priority to and the benefit of U.S. Provisional Patent Application No. 63/310,866, Filed Dec. 15, 2023. U.S. Provisional Patent Application No. 63/310,866 is hereby incorporated by reference in its entirety.

### FIELD

The present disclosure relates generally to machine learning. More particularly, the present disclosure relates to systems and methods that enhance the performance of sequence processing models with respect to recommendation tasks.

### BACKGROUND

A traditional software stack employed in a typical recommender system comprises various components, each serving a specialized function in the overall recommendation process. The architecture often starts with a database layer, the foundational component where all the user, item, and interaction data is stored. This layer is often built using traditional relational database systems like MySQL or more advanced NoSQL databases like MongoDB based on the scale of data. Often, the next component in the stack is the data processing layer, typically composed of big data processing systems such as MapReduce, Spark, or Flink. These tools help transform, filter, and prepare data for the recommendation algorithm. The recommendation engine itself forms the core of the software stack. This component uses various algorithms like collaborative filtering, content-based filtering, or hybrid models to generate recommendations. The application layer forms the topmost component of the stack, interfacing with the user and triggering the recommender system upon user interaction. This layer is often built using various programming languages and web technologies, including Python, Java, JavaScript, HTML, and CSS. Last but not least, the recommender system may also include a feedback loop for continuous learning and improvement. The feedback loop collects user feedback on recommendations, incorporates it into the system, and refines future recommendations accordingly.

However, these traditional recommender systems come with certain drawbacks, particularly related to their data storage requirements and user interaction data handling. The need for a database layer capable of storing large volumes of user, item, and interaction data means that these systems are dependent on extensive databases. This requirement can be technically challenging to meet, especially for systems handling a growing number of users and items. Additionally, the need to continually update these databases with new user interaction data can also be technically demanding. Furthermore, traditional recommendation systems often require the storage of long-range user interaction data to provide accurate and personalized recommendations. This requirement presents challenges in terms of data privacy and security, as it involves storing sensitive user data over extended periods. In addition to these technical challenges, traditional recommender systems also tend to be complex, consisting of multiple components, each serving a specialized function. This complexity can make these systems prone to failures and difficult to maintain and update.

### SUMMARY

Aspects and advantages of embodiments of the present disclosure will be set forth in part in the following description, or can be learned from the description, or can be learned through practice of the embodiments.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a computer-implemented method to train a sequence processing model for use by a recommendation system. The computer-implemented method includes obtaining, by a computing system may include one or more computing devices, an item dataset that describes a plurality of items included in a candidate pool. The method also includes generating, by the computing system, a plurality of auxiliary prompts for use in training the sequence processing model, where each auxiliary prompt may include a prompt input and a prompt output, and where the plurality of auxiliary prompts encode recommendation-related knowledge about the plurality of items. The method also includes training, by the computing system, the sequence processing model using the plurality of auxiliary prompts. The method also includes providing, by the computing system, the trained sequence processing model for use in a recommendation system. Other embodiments of this aspect include corresponding computer systems, apparatus, and computer programs recorded on one or more computer storage devices, each configured to perform the actions of the methods.

Implementations may include one or more of the following features. The computer-implemented method where the one or more auxiliary prompts may include item embedding prompts that encode knowledge about the plurality of items. The item dataset describes, for each of the plurality of items, one or more attribute values for one or more item attributes; and for at least one of the item embedding prompts: the prompt input identifies one of the plurality of items and the prompt output includes the attribute value for the identified item for at least one of the one or more attributes. The item dataset describes, for each of the plurality of items, one or more attribute values for one or more item attributes; and for at least one of the item embedding prompts: the prompt input includes an attribute value for at least one of the one or more attributes and the prompt output identifies one or more of the items that have the provided attribute value. The one or more attributes may include title, categories, brands, descriptions, or reviews. The item dataset specifies a plurality of users and historical interactions between each of the plurality of users and one or more of the plurality of items. The one or more auxiliary prompts may include BPR loss reduction prompts that encode knowledge about the historical interactions of between the users and the items. For at least one of the BPR loss reduction prompts: the prompt input identifies a user, a positive item for the user, and a negative item for the user; and the prompt output identifies the positive item. The one or more auxiliary prompts may include masked item modeling prompts; and for at least one of the masked item modeling prompts: the prompt input contains a list of items that includes a masked item; and the prompt output identifies an item that was masked to generate the masked item. Generating the masked item modeling prompts may include: identifying, based on the item dataset, a sequence of items with which one of the plurality of users has interacted; and masking one of the sequence of items with a masked item to generate the prompt input; where the one of the sequence of items that is masked is a non-terminal item in the sequence of items. Identifying, based on the item dataset, the sequence of items with which one of the plurality of users has interacted may include applying a sliding window to extract the sequence of items. In some or all of the plurality of auxiliary prompts a user identifier for a user of the plurality of users is replaced with a sequence of items with which the user has interacted. In some or all of the plurality of auxiliary prompts an item identifier for an item of the plurality of items is replaced with a shortened identifier. The computer-implemented method may include, after training, by the computing system, the sequence processing model using the plurality of auxiliary prompts but before providing, by the computing system, the trained sequence processing model for use in the recommendation system: training, by the computing system, the sequence processing model using one or more recommendation-task prompts. Providing, by the computing system, the trained sequence processing model for use in the recommendation system may include instructing, by the computing system, the trained sequence processing model to perform a retrieval task. Providing, by the computing system, the trained sequence processing model for use in the recommendation system may include instructing, by the computing system, the trained sequence processing model to perform a ranking task. Providing, by the computing system, the trained sequence processing model for use in the recommendation system may include instructing, by the computing system, the trained sequence processing model to perform a rating prediction task. The sequence processing model has not been previously trained on data specific to the candidate pool. A recommendation system may include a sequence processing model that has been trained on the auxiliary prompts described herein. One or more non-transitory computer-readable media may collectively store a sequence processing model that has been trained on the auxiliary prompts described in any preceding claim.

A computer system may include: one or more processors and one or more non-transitory computer-readable media that collectively store: a sequence processing model trained using one or more auxiliary prompts as described herein; and computer-executable instructions for performing operations, the operations may include: receiving a query associated with a user; generating a recommendation-task prompt based on the query; processing the recommendation-task prompt with the sequence processing model to obtain a recommendation output that identifies one or more items; and providing the one or more items as a recommendation output for the user. The computer system may include a user computing device and the sequence processing model is implemented on-device on the user computing device. The computer system does not store an item dataset such that the recommendation output that identifies the one or more items is generated without accessing the item dataset. Implementations of the described techniques may include hardware, a method or process, or computer software on a computer-accessible medium.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

Detailed discussion of embodiments directed to one of ordinary skill in the art is set forth in the specification, which makes reference to the appended figures, in which:

FIGS. 1A-E are block diagrams of example approaches for aligning sequence processing models with recommendation knowledge according to example implementations of aspects of the present disclosure;

FIG. 2 is a flow chart diagram illustrating an example method for training a machine-learned model according to example implementations of aspects of the present disclosure;

FIG. 3A is a block diagram of an example processing flow for using machine-learned model(s) to process input(s) to generate output(s) according to example implementations of aspects of the present disclosure;

FIG. 3B is a block diagram of an example sequence processing model according to example implementations of aspects of the present disclosure;

FIG. 4 is a block diagram of an example technique for populating an example input sequence for processing by a sequence processing model according to example implementations of aspects of the present disclosure;

FIG. 5 is a block diagram of an example model development platform according to example implementations of aspects of the present disclosure;

FIG. 6 is a block diagram of an example training workflow for training a machine-learned model according to example implementations of aspects of the present disclosure;

FIG. 7 is a block diagram of an inference system for operating one or more machine-learned model(s) to perform inference according to example implementations of aspects of the present disclosure;

FIG. 8 is a block diagram of an example networked computing system according to example implementations of aspects of the present disclosure;

FIG. 9 is a block diagram of an example computing device according to example implementations of aspects of the present disclosure; and

FIG. 10 is a block diagram of an example computing device according to example implementations of aspects of the present disclosure.

### DETAILED DESCRIPTION

Traditional recommender systems, despite their effectiveness, come with certain drawbacks, particularly related to their data storage requirements and user interaction data handling. On the other hand, sequence processing models, such as so-called “large language models” for example, have strong generalization abilities, but lack the specific knowledge related to recommendation tasks. In view of this dichotomy, the present disclosure provides systems and methods that enhance the performance of sequence processing models with respect to recommendation tasks. The improved recommendation performance afforded by the proposed techniques enables a conventional recommender system to be replaced with the use of a sequence processing model for recommendation generation. Thus, the proposed technology aims to bridge the knowledge gap between sequence processing models and conventional recommender systems while resulting in a number of technical benefits such as a reduced need for large databases storing large sets of user-item interaction data required for multiple recommendation system components in a deployed system, reduced storage of long-range user history data, enabling potential on-device implementations, and other benefits.

In particular, example implementations of the present disclosure mitigate this knowledge gap by aligning sequence processing models with recommendation knowledge. Example training systems can generate natural language prompts, which can be referred to as ‘auxiliary prompts’, that encode different types of recommendation-related knowledge, such as item attributes and user preferences. These auxiliary prompts encode into natural language format various operations and losses that can be used to impart recommendation knowledge to a sequence processing model, including item embedding, Bayesian personalized ranking (BPR), and masked item modeling.

The proposed techniques improve the performance of sequence processing models on fundamental recommendation tasks such as retrieval, ranking, and rating-prediction. The auxiliary prompt structure introduces recommendation-related knowledge effectively, even for domains that are relatively foreign or “unobserved” to sequence processing models. The resulting recommendation-tuned sequence processing models provide a number of technical benefits, as outlined below.

More particularly, one example aspect of the present disclosure is directed to systems and methods to train a sequence processing model for use in a recommendation system, with a focus on improving the performance of retrieval, ranking and rating predictions tasks. An example method can include obtaining an item dataset that describes a variety of items included in a candidate pool. The item dataset can describe, for each of the items, one or more attribute values for one or more item attributes such as title, categories, brand, price, attributes, descriptions, and reviews.

The example method can then include generating a series of auxiliary prompts for use in training the sequence processing model. Each auxiliary prompt can include a prompt input and a prompt output, which together encode recommendation-related knowledge about the items. For instance, an auxiliary prompt could ask a question about the properties of an item in the input and provide the answer in the output. The auxiliary prompts that encode different types of recommendation-related knowledge can, in some cases, correspond to natural language representations of operations and losses that have shown good performance when used by conventional recommendation systems.

One example auxiliary prompt structure, which can be referred to as an item embedding prompt, encodes an item embedding approach into a natural language representation. Item embedding is a common practice adopted by representation-based recommenders where items are represented in a common vector space. The present disclosure mimics the item embedding process using natural language expressions. By asking questions about the properties of an item in the input and answering them in the output, item embedding prompts are generated.

Another example auxiliary prompt structure, which can be referred to as a BPR loss reduction prompt, represents a reduction of Bayesian personalized ranking (BPR) loss into a natural language prompt format. BPR loss is a loss function that has been used in conventional recommenders in learning to optimize the model parameters for ranking. The BPR loss reduction prompt transforms this process into a natural language prompt format. In particular, by asking and answering questions about the user's choice between the positive item and the negative item, BPR loss reduction prompts can be generated.

Another example auxiliary prompt structure, which can be referred to as a masked item modeling prompt, represents a transformation of a masked item modeling training framework into a natural language prompting format. In particular, typical masked modeling applies a Cloze objective where random entries in an input sequence are replaced with a special token “[mask]” and the model learns to predict the masked entry based on its left and right context. The present disclosure transforms this process into a natural language prompting format by masking and identifying random items within the users' purchase sequences. This helps to capture distinct historical interactions and their context.

Other aspects of the present disclosure are directed to fine-tuning and evaluating the sequence processing model-based recommender systems. This can be done by first generating recommendation-task as well as auxiliary-task prompts. Next, the sequence processing model backbone is fine-tuned using the recommendation-task prompts along with the auxiliary-task prompts. For example, the sequence processing model backbone can first be trained using the auxiliary-task prompts and then subsequently trained using the recommendation-task prompts. Finally, the fine-tuned models are evaluated on and/or deployed for fundamental recommendation tasks, e.g., retrieval, ranking, and rating-prediction.

Another aspect of the present disclosure relates to a method of simplifying the representation of the items to reduce the complexity of the input/output spaces. For example, in some or all of the auxiliary prompts, an item identifier for an item can be replaced with a shortened identifier. This makes it easier for the sequence processing model to process and understand the information.

Another aspect of the present disclosure relates to techniques that operate to relieve sequence processing models from memorizing the user identifiers (IDs), which is challenging due to the substantial volume of the user IDs. For example, in some or all of the training prompts, a user identifier for a user can be replaced with a sequence of items with which the user has interacted. This can enable the sequence processing model to model the item space more directly, rather than attempting to memorize a large number of user IDs.

Once finetuned or otherwise trained, the sequence processing model can be deployed for use in a recommendation system. For example, the trained sequence processing model can be instructed or otherwise used to perform a retrieval task, a ranking task, or a rating prediction task. In some cases, the sequence processing model deployed to perform these tasks may not have been previously trained on data specific to the candidate pool. Therefore, the proposed techniques result in a sequence processing model that is a flexible and adaptable solution for various recommendation systems.

The systems and methods of the present disclosure provide a number of technical effects and benefits. As one example, the need for one or more large databases in a deployed recommendation system is eliminated, as the trained sequence processing model is the primary component to be deployed. This represents a substantial technical improvement over traditional recommender systems, which necessitate extensive databases to store and process user, item, and interaction data. The proposed method can leverage the inherent capabilities of sequence processing models to understand and generate recommendations based on the encoded knowledge, thereby reducing the dependency on voluminous databases.

As another, related technical benefit, the proposed technology offers more privacy and security as there is no need to store an entire set of long-range user data. In conventional systems, user data about all past user interactions is stored and processed in databases, which could potentially be exploited or compromised. However, with the sequence processing model-based approach, recommendations can be generated based on the knowledge encoded within the model using only a short-range of user interactions, significantly reducing the need for extensive data storage and thereby enhancing data privacy and security.

As another example technical benefit, the proposed technology is designed such that some implementations of the approach can be implemented on-device. For example, because the sequence processing model has learned representations of the items included in the item dataset, access to the item dataset (e.g., as stored in a database) is not required and, therefore, some implementations of the model can be run on-device. This is a significant technical advancement as it enables the recommendation system to operate locally on the user's device, reducing the reliance on constant network connectivity and server-side processing, thereby conserving network bandwidth and reducing data transmission costs. This on-device implementation also enhances the speed and responsiveness of the system, providing a robust solution for real-time recommendations. In addition, the ability to implement the recommendation system on-device represents a further privacy benefit, as data about user interactions does not necessarily need to leave the user's device. Similarly, the use of an on-device sequence processing model affords an opportunity to create a personalized recommendation model in a privacy-preserving manner.

As another example technical benefit, the refined method offers fewer points of failure compared to traditional systems. By simplifying the architecture and transitioning from a multi-component system to a singular sequence processing model, the risk of system breakdowns and failures is significantly reduced. This results in a more reliable and robust recommendation system, contributing to enhanced system performance.

As another example technical benefit, the use of sequence processing models opens up the possibility of leveraging specialized hardware and investments in sequence processing model performance. As sequence processing models are a major area of research and development in the field of machine learning, there are numerous ongoing efforts to optimize their performance through specialized hardware and software solutions, including advancements with respect to specialized hardware accelerators such as application-specific integrated circuits (ASICs) and graphics processing units (GPUs). By adopting sequence processing models in the proposed technology, the recommendation system can benefit from these advancements, providing a technically superior and future-proof solution.

The proposed sequence processing model-based recommendation system can be applied to a number of different applications or use cases. As one example, the sequence processing model-based recommendation system can be used to provide personalized content recommendations. For example, the trained sequence processing model can be used to create personalized content recommendations for users on various platforms, such as video streaming services, e-commerce websites, or social media platforms. The system can analyze the user's past behavior, preferences, and interactions to suggest relevant content, products, or posts.

As another example, the sequence processing model-based recommendation system can be incorporated into a search engine or other information retrieval system. For example, search engines can use the sequence processing model to improve search results by better understanding the intent behind a user's search query. The model and search engine can work cooperatively to provide more relevant search results, enhancing the user's experience and satisfaction. As yet another example, the sequence processing model-based recommendation system could be incorporated into an e-learning platform. In e-learning platforms, the sequence processing model can provide personalized learning recommendations to students based on their learning style, progress, and preferences, enhancing the learning experience.

With reference now to the Figures, example embodiments of the present disclosure will be discussed in further detail.

### Example Alignment Techniques

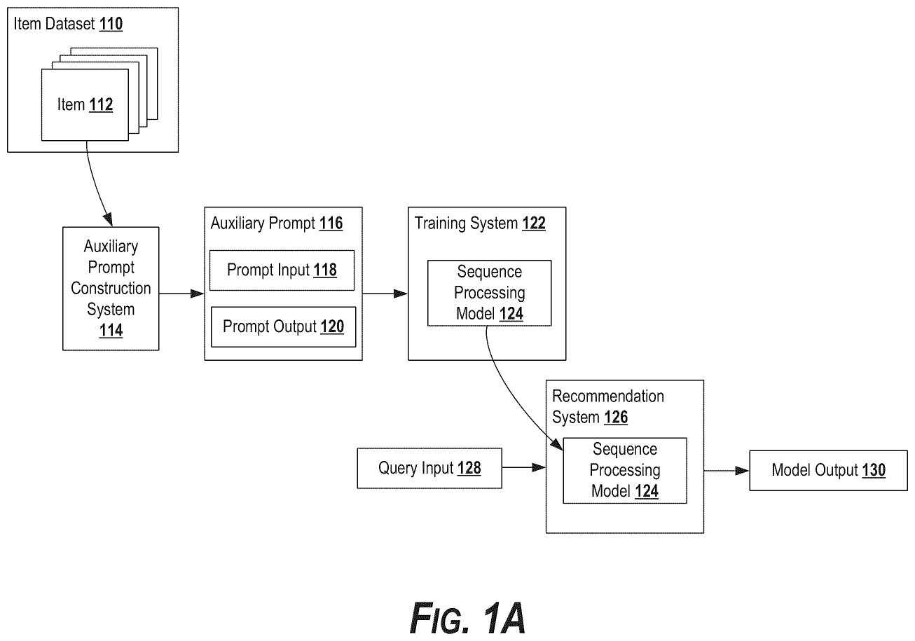

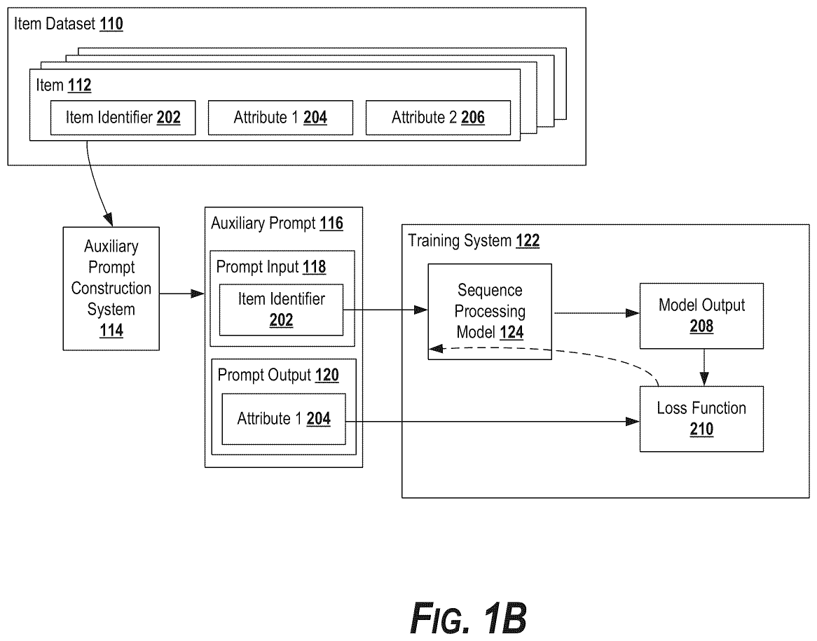

FIG. 1A illustrates an example configuration of a system for training a sequence processing model with recommendation knowledge. The system can include an item dataset 110. The dataset 110 can store a plurality of items, such as, for example, item 112. Alternatively or additionally, the dataset 110 can store data about a plurality of users, and the users' interactions with items, as illustrated with reference to other figures.

The item dataset 110 can be connected to an auxiliary prompt construction system 114 that can generate auxiliary prompts 116 based on the items in the item dataset 110. Each auxiliary prompt 116 can comprise a prompt input 118 and a prompt output 120, which together encode recommendation-related knowledge about the items.

The auxiliary prompt construction system 114 can send the auxiliary prompts 116 to a training system 122. The training system 122 can utilize these prompts to train a sequence processing model 124.

The auxiliary prompt construction system 114 and/or the training system 122 can be configured to perform specific operations or actions by virtue of having software, firmware, hardware, or a combination thereof installed on a system that in operation causes the system to perform these actions.

After training, the sequence processing model 124 can be deployed as part of a recommendation system 126. The recommendation system 126 can receive a query input 128 and use the trained sequence processing model 124 to process this input and generate a model output 130. The model output 130 can be used to provide recommendations or other outputs based on the query input 128.

### Example Attribute-Based Item Modeling Techniques

FIG. 1B depicts an example configuration of a system designed to train a sequence processing model utilizing item-specific attributes. The system can include an item dataset 110, which can store multiple items, such as item 112. Within the item dataset 110, each item can be associated with an item identifier 202 and multiple attributes, such as attribute 1 204 and attribute 2 206.

Connected to the item dataset 110 is an auxiliary prompt construction system 114. This system can generate auxiliary prompts 116, each comprising a prompt input 118 and a prompt output 120. In this example, the prompt input 118 can include the item identifier 202, and the prompt output 120 can include attribute 1 204. These auxiliary prompts 116 can be structured to encode knowledge about item attributes into the sequence processing model.

The auxiliary prompts 116 are provided to a training system 122, which uses these prompts to train a sequence processing model 124. The sequence processing model 124 processes the information from the auxiliary prompts 116 and generates a model output 208. The effectiveness of the training can be evaluated using a loss function 210, which can measure the discrepancy between the expected output and the model output 208 generated by the sequence processing model 124.

FIG. 1C presents an example system configuration for training a sequence processing model using a reverse methodology of auxiliary prompts. The system includes an item dataset 110 that can store multiple items such as item 112. Each item in the item dataset 110 can be associated with an item identifier 202 and several attributes, exemplified here as attribute 1 204 and attribute 2 206.

The system also incorporates an auxiliary prompt construction system 114, which is configured to generate auxiliary prompts 116. In this instance, each auxiliary prompt 116 comprises a prompt input 118 and a prompt output 120, where the prompt input 118 includes attribute 1 204 and the prompt output 120 includes the item identifier 202. This configuration represents a reversal of the attribute-to-identifier mapping shown in FIG. 1B.

These auxiliary prompts 116 are forwarded to a training system 122, which employs these prompts to facilitate the training of a sequence processing model 124. The sequence processing model 124 processes the auxiliary prompts 116 and produces a model output 308. The accuracy or efficacy of the training can be evaluated using a loss function 210, which measures the discrepancies between the expected outputs and the actual model output 308 generated by the sequence processing model 124.

This figure illustrates an example of how a sequence processing model can be trained to associate specific attributes with corresponding item identifiers, utilizing a reversed input-output prompt structure within the auxiliary prompts 116.

### Example Masked Item Modeling Techniques

FIG. 1D depicts an example system configuration for training a sequence processing model using masked item modeling prompts. The system includes an item dataset 110, which can store user data 402. Each user in the user data 402 can be associated with a user identifier 403 and has interactions with multiple items, exemplified by first item identifier 504, second item identifier 506, and third item identifier 508. For example, the user may have had a positive interaction with each of the items 504, 506, 508.

An auxiliary prompt construction system 114 is connected to the item dataset 110 and is configured to generate auxiliary prompts 116. In this configuration, each auxiliary prompt 116 comprises a prompt input 118 and a prompt output 120. The prompt input 118 can include the first item identifier 504, a masked item identifier 510 representing an undisclosed item, and the third item identifier 508. The prompt output 120 includes the second item identifier 506, which corresponds to the masked item identifier 510 in the prompt input 118. The masking of the second identifier is provided as an example only. Any one or more of the item identifiers can be masked.

These auxiliary prompts 116 are provided to a training system 122, which uses these prompts to facilitate the training of a sequence processing model 124. The sequence processing model 124 processes the auxiliary prompts 116 and generates a model output 512. The training effectiveness is evaluated using a loss function 210, which measures the accuracy of the model in predicting the masked item based on its context within the sequence of items.

This figure illustrates an example method by which a sequence processing model can be trained to predict masked or missing items in a sequence, utilizing a structured input-output prompt configuration within the auxiliary prompts 116.

Thus, in some implementations, the present disclosure designs data samples that encode recommendation knowledge to align LLMs with a target recommendation domain. One example approach is a Masked Item Modeling (MIM) technique. In some implementations, MIM can apply a Cloze objective. At each training step, random items in the input user sequence are replaced with a special token “[mask]”, and the model learns to recover the masked items based on its surrounding context. An example of the masking process:

$$\begin{matrix}Input : [ {i}_{1} , {i}_{2} , {i}_{3} , {i}_{4} , {i}_{5} ] {\to }^{random asking} \\ [ {i}_{i} , {[ mask ]}_{1} , {i}_{3} , {[ mask ]}_{2} , {i}_{5} ] \\ Label {: [ mask ]}_{1} = {{i}_{2 ,} [ mask ]}_{2} = {i}_{4}\end{matrix} \qquad ( 1 )$$

In some implementations, the MIM loss can be computed as follows in conventional sequential recommenders:

$${ℒ}_{M I M} = \frac{1}{\vert {u}_{m}^{} \vert} {\sum }_{{i}_{m} ∈ {u}_{m}^{}} - log P ( {i}_{m} \vert {u}_{′}^{} ) , \qquad ( 2 )$$

where [symbol] ′ᵤ is the masked version of user sequence [symbol] ᵤ, [symbol] ᵤ stands for the masked items in [symbol] ᵤ·P(·), the probability of observing iₘ given [symbol] ᵤ, is calculated, in some implementations, from deep bidirectional self-attention.

For the example MIM loss of Equation 2, given purchase sequence: [i₁, i₂, i₃, i₄, i₅], some example implementations can generate prompts, e.g., Input: “A user has purchased the following products: Item ID: [ID]ᵢ_{₁}, Title: [Title]ᵢ_{₁}; [masked item]; Item ID: [ID]ᵢ_{₃}, Title: [Title]ᵢ_{₃}; [masked item]; Item ID: [ID]ᵢ_{₅}, Title: [Title]ᵢ_{₅}. What are the masked items, in chronological order?”, and Output: “Item ID: [ID]ᵢ_{₂}, Title: [Title]ᵢ_{₂}; Item ID: [ID]ᵢ_{₄}, Title: [Title]ᵢ_{₄};”. To accommodate long sequences, some example implementations introduce a sliding window w and each prompt considers one sub-sequence: [iₖ, iₖ₊₁ . . . , i_{k+w-1}], where 1≤k≤max(1,(L−w+1)) and L is the total length of the user sequence. The resulting MIM data samples encodes the correlations between the masked items and the rest of the sequences.

In addition to MIM that considers a single item for each mask, some example implementations also mask out and recover a consecutive span of tokens to encode fine-grained item correlations contained in the users' purchase sequences.

Given a user sequence, some example implementations sample a sub-sequence by randomly deciding a starting item and a sub-sequence length Lₛ, where 2≤Lₛ≤w and w is the sliding window for accommodating long sequences. These sub-sequences, referred to as MLM data samples, supplement the MIM data samples: through span corruption, i.e., masking and recovering consecutive spans of tokens, LLMs learn to model more fine-grained correlations across multiple continuous items from the MLM data samples.

### Example Bayesian Personalized Ranking (BPR) Techniques

FIG. 1E illustrates an example configuration of a system designed to train a sequence processing model using Bayesian Personalized Ranking (BPR) loss reduction prompts. The system includes an item dataset 110, which can store user data 402 for each of a number of users. The user data 402 for each user can include a user identifier 403 and can have interactions with items that are identified as positive item identifier 404 and negative item identifier 406.

For example, a positive interaction between a user and an item typically refers to a favorable engagement, such as a user purchasing, liking, or positively reviewing an item, indicating satisfaction or preference. Conversely, a negative interaction suggests an unfavorable engagement, where a user may return, dislike, or negatively review an item, reflecting dissatisfaction or disinterest. In other implementations, randomly selected items can be used in place of negative items.

Referring still to FIG. 1E, connected to the item dataset 110 is an auxiliary prompt construction system 114, which is configured to generate auxiliary prompts 116. In this example, each auxiliary prompt 116 comprises a prompt input 118 and a prompt output 120. The prompt input 118 can include the user identifier 403, the positive item identifier 404, and the negative item identifier 406. The prompt output 120 can include the positive item identifier 404, indicating a preference for the positive item over the negative item.

These auxiliary prompts 116 are provided to a training system 122, which uses these prompts to facilitate the training of a sequence processing model 124. The sequence processing model 124 processes the auxiliary prompts 116 and generates a model output 408. The training effectiveness is evaluated using a loss function 210, which measures the accuracy of the model in predicting the positive item as the preferred choice over the negative item.

This figure illustrates an example method by which a sequence processing model can be trained to understand user preferences based on positive and negative item interactions, using a structured input-output prompt configuration within the auxiliary prompts 116.

Thus, some example implementations contrast dissimilar items. Some example implementations can leverage BPR loss reduction with natural language prompts for training LLMs.

The objective of BPR loss reduction in conventional recommenders is:

$${ℒ}_{B P R} = {𝔼}_{( u , {i}^{+} ) ∼ {p}_{pos}} - log σ ( s ( u , {i}^{+} ) - s ( u , {i}^{-} ) ) , \qquad ( 3 )$$

where (u, i⁺) is a pair of a user u and an item i⁺ sampled from the distribution of positive pairs ρₚₒₛ. As one example, u may have interacted with i⁺ while i⁻ is a randomly sampled negative item that u has not interacted with. As another example, i⁻ may be an item that u had a negative interaction with. The similarity between u and i⁺, denoted by s(u, i⁺), can be calculated by taking the dot product of their representations. σ(·) is the Sigmoid function.

Some example implementations elicit user preferences by generating prompts with binary choices that contrast a positive item and a negative item. Each prompt takes the form of a binary decision, e.g., Input: “A user has purchased . . . Which of the following two products would the user buy next? Item ID: [ID]ᵢ_{^{−}}, Title: [Title]ᵢ_{^{−}}; Item ID: [ID]ᵢ_{⁺}, Title: [Title]ᵢ_{⁺}.”, and Output: “Item ID: [ID]ᵢ_{⁺}, Title: [Title]ᵢ_{⁺}”.

Some example implementations adopt a sliding window w to accommodate long user sequences and the positive item is always the one next to the sliding window. These BPR data samples encode dissimilarities between the purchased items and the rest of the items in the dataset.

### Example Recommendation-Task Data Generation

Existing recommenders with LLM backbones adopt prompts that primarily convey the recommendation tasks by providing directions on how to perform them. Such information is essential, yet insufficient for representing the target recommendation domain.

Some example implementations use prompts that help LLMs comprehend the target recommendation domain in addition to the recommendation tasks. Specifically, some example implementations reduce the complexity of the input/output spaces.

As one example, some example implementations can eliminate user IDs and represent the users by their historical purchases. Consequently, these implementations relieve LLMs from memorizing a substantial volume of user IDs.

As another example, some example implementations can include both the IDs and the titles of the items, which makes it easier for LLMs to recognize the items. Notably, in some implementations, ranking candidates and items in the output are represented solely by their IDs to reduce the length of the prompts and maintain a smaller output space. For example, the raw item IDs (e.g., ‘0000031852’) can be mapped into shorter ones (e.g., ‘I123’) to reduce input/output space complexity. To fully present the users' historical purchases to LLMs, some example implementations can again adopt a sliding window w.

### Example Recommendation Tasks

The trained model can be used on any number of recommendation tasks, including the following three example recommendation tasks: retrieval, which retrieves the ground truth item that a user interacted with from the entire dataset; ranking, which chooses the ground truth item that a user interacted with from a candidate pool (e.g., of size 100) (e.g., 1 positive item and 99 negative items sampled based on popularity); rating prediction, which classifies an interaction as either “like” or “dislike” (e.g., interactions with ratings >3 are considered as “like”).

In some implementations, for the retrieval task, the trained sequence processing model can receive a user query as input, which might include a user identifier, user preferences, search terms, and/or contextual information about the user's past interactions. The output for this task would be the identification of a specific item from the entire dataset that best matches the user's query. This could be an item that the user has previously interacted with or one that closely aligns with their preferences as inferred by the model.

In some implementations, for the ranking task, the input could include a list of items. These items are often presented as a candidate pool where the items are chosen based on previous interactions or popularity metrics within the dataset. The output from the sequence processing model would be a ranking of these items, prioritizing them in order of relevance or likelihood of user preference. The model's training enables it to discern subtle preferences and distinctions between items.

In some implementations, for the rating prediction task, the input to the sequence processing model can include an item identifier, item attributes, user identifier, detailed item descriptions, and/or user-item interaction data, such as viewing time, previous ratings, or purchase history. The output can include a classification of the interaction into categories such as “like” or “dislike” or within graded classes such as 1 through 5. In some examples, interactions are classified based on a threshold, for instance, rating predictions greater than 3 might be considered as “like.” Alternatively or additionally, the output can include a regression output that provides a scalar number in a range such as, for example, 1 to 5. This task can include predicting user satisfaction with an item. The model applies its understanding of user behavior and item characteristics learned through the auxiliary prompts to forecast user reactions to items.

### Example Methods

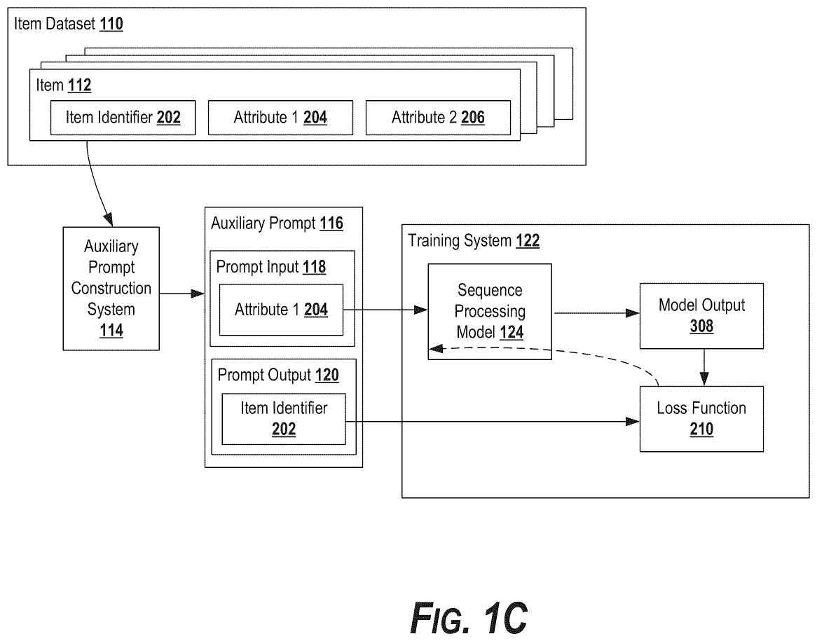

FIG. 2 depicts a flowchart of a method 100 for training one or more machine-learned models according to aspects of the present disclosure. For instance, an example machine-learned model can include a sequence processing model.

One or more portion(s) of example method 100 can be implemented by a computing system that includes one or more computing devices such as, for example, computing systems described with reference to the other figures. Each respective portion of example method 100 can be performed by any (or any combination) of one or more computing devices. Moreover, one or more portion(s) of example method 100 can be implemented on the hardware components of the device(s) described herein, for example, to train one or more systems or models. FIG. 2 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 2 is described with reference to elements/terms described with respect to other systems and figures for exemplary illustrated purposes and is not meant to be limiting. One or more portions of example method 100 can be performed additionally, or alternatively, by other systems.

At 102, example method 100 can include obtaining a training instance. A set of training data can include a plurality of training instances divided between multiple datasets (e.g., a training dataset, a validation dataset, or testing dataset). A training instance can be labeled or unlabeled. Although referred to in example method 100 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure. As one example, a training instance can be or include an auxiliary prompt.

At 104, example method 100 can include processing, using one or more machine-learned models, the training instance to generate an output. The output can be directly obtained from the one or more machine-learned models or can be a downstream result of a chain of processing operations that includes an output of the one or more machine-learned models. For example, processing the training instance can include processing the auxiliary prompt (e.g., a prompt input portion of the auxiliary prompt).

At 106, example method 100 can include receiving an evaluation signal associated with the output. The evaluation signal can be obtained using a loss function. For example, the loss function can compare the output of the model to a prompt output portion of an auxiliary prompt. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 108, example method 100 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 100 can include implementing a number of generalization techniques (e.g., weight decays, dropouts, etc.) to improve the generalization capability of the models being trained.

In some implementations, example method 100 can be implemented for training a machine-learned model from an initialized state to a fully trained state (e.g., when the model exhibits a desired performance profile, such as based on accuracy, precision, recall, etc.).

In some implementations, example method 100 can be implemented for particular stages of a training procedure. For instance, in some implementations, example method 100 can be implemented for pre-training a machine-learned model. Pre-training can include, for instance, large-scale training over potentially noisy data to achieve a broad base of performance levels across a variety of tasks/data types. In some implementations, example method 100 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

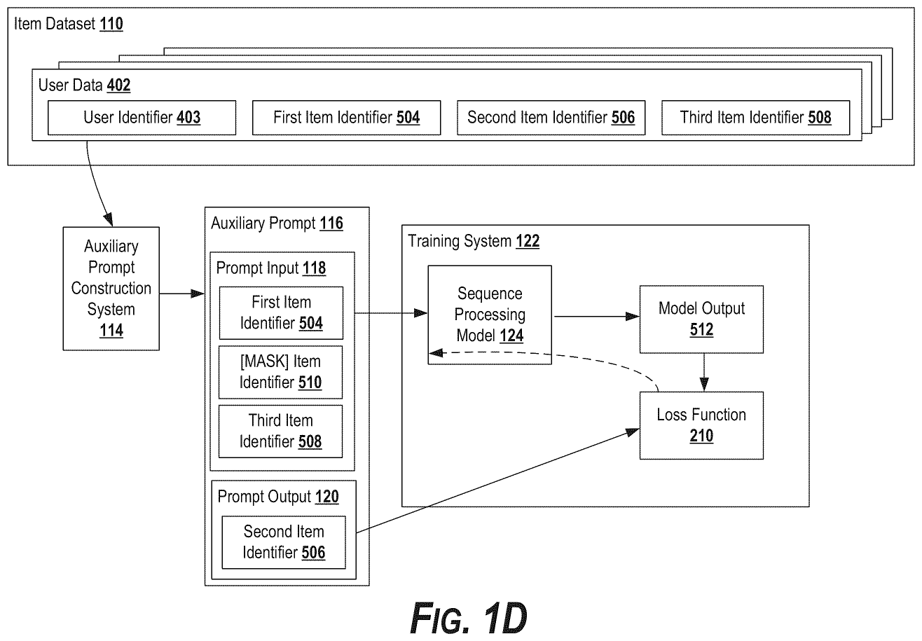

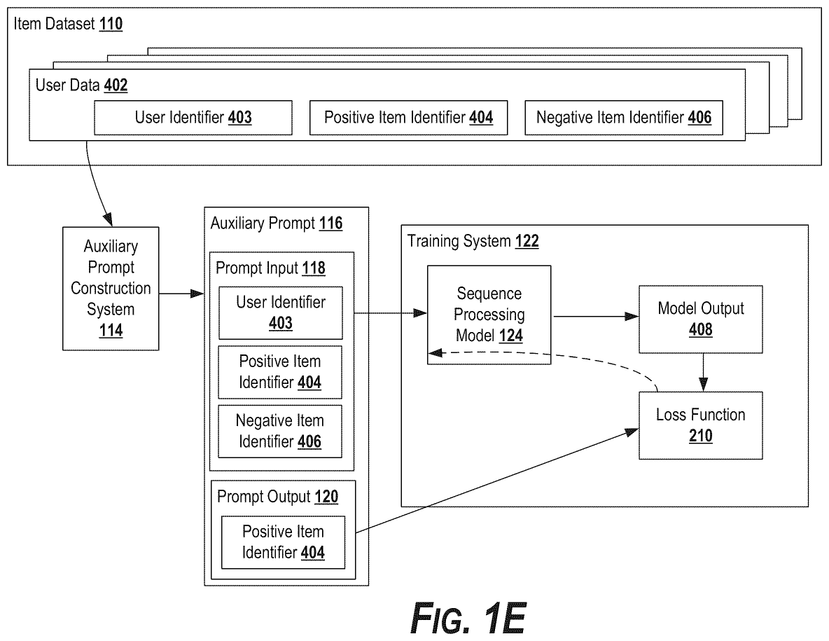

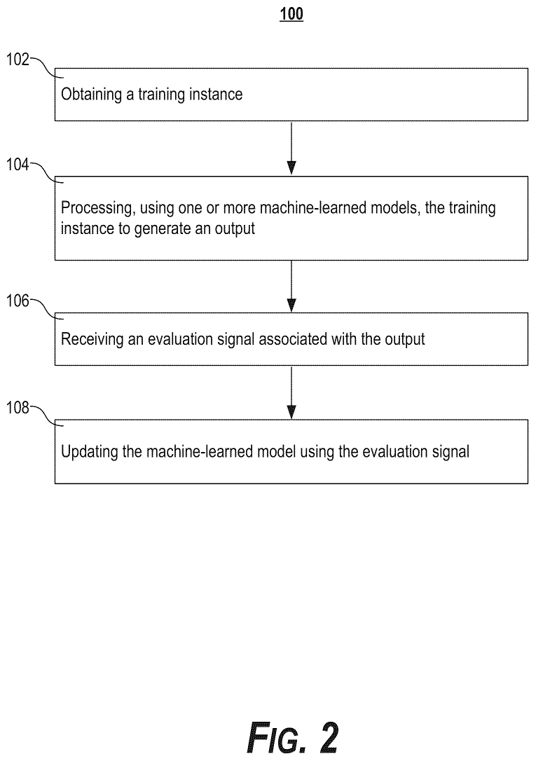

FIG. 3A is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, arXiv:2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

### Example Machine-Learned Sequence Processing Models

FIG. 3B is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, Google, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, arXiv:2010.11929v2 (Jun. 3, 2021), audio domains, see, e.g., Agostinelli et al., MusicLM: Generating Music From Text, arXiv:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, Proceedings of the 2018 Conference on Empirical Methods in Natural Language Processing (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 3B can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, arXiv:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, arXiv:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

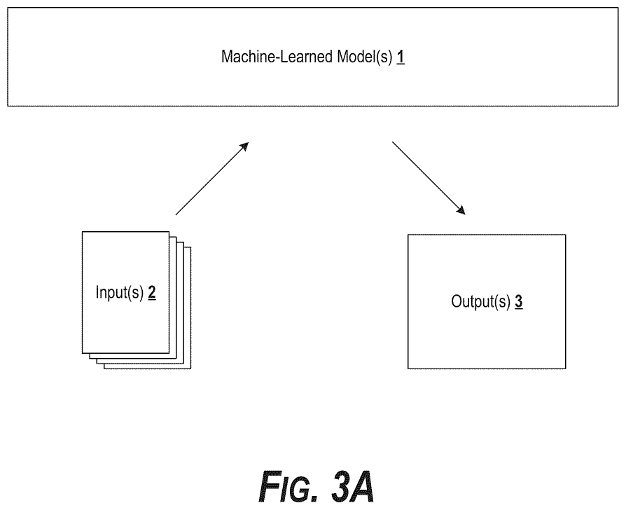

FIG. 4 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

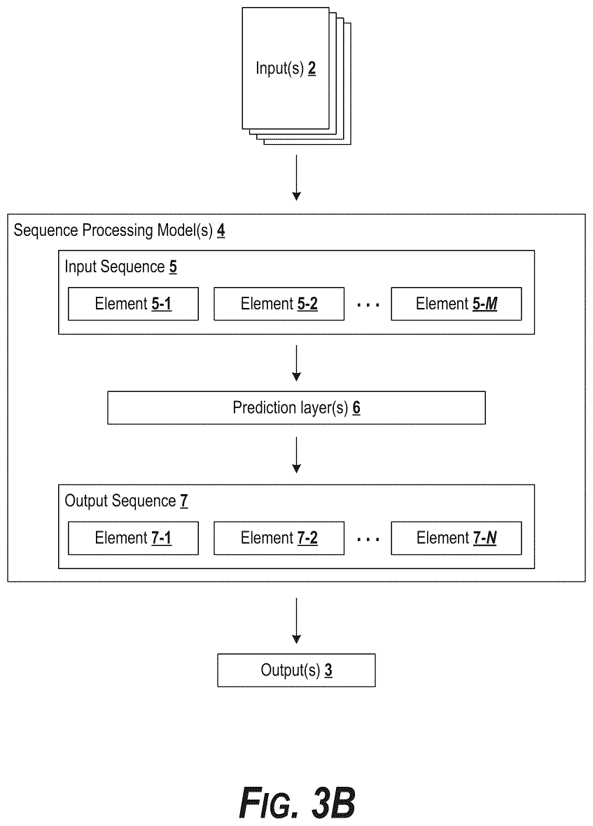

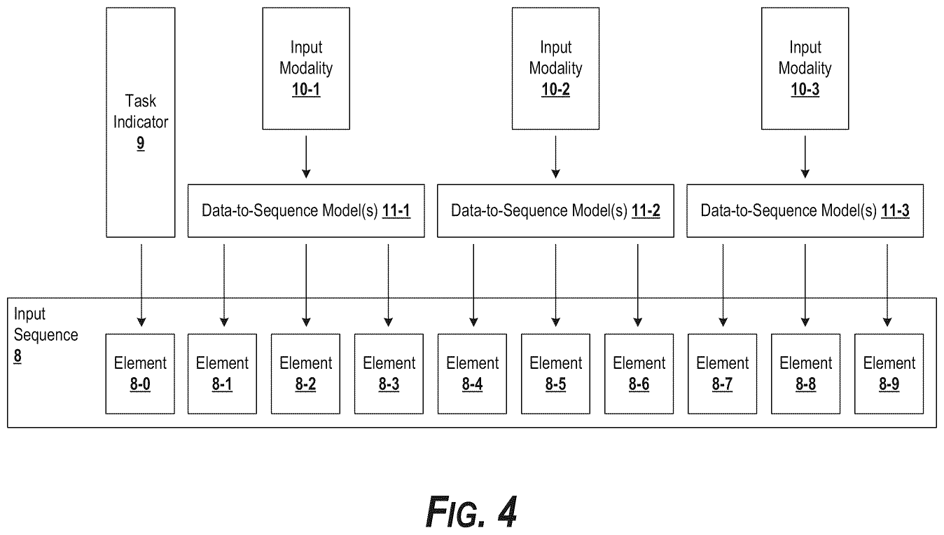

FIG. 5 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 100 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

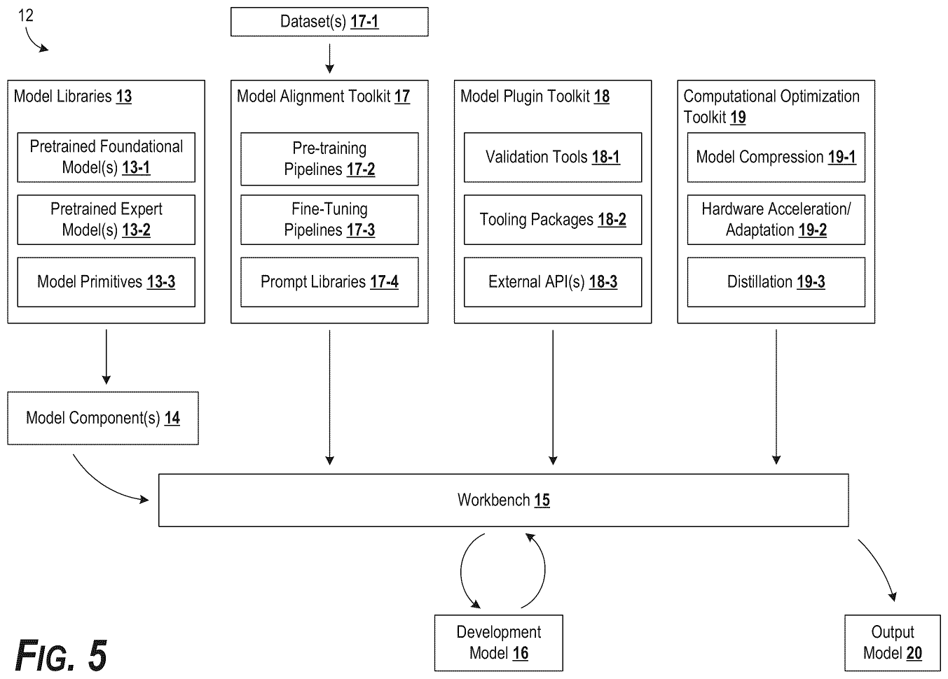

FIG. 6 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 6 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

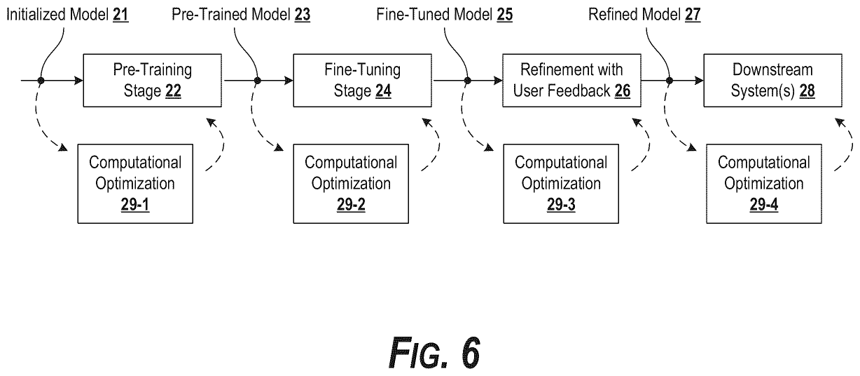

FIG. 7 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

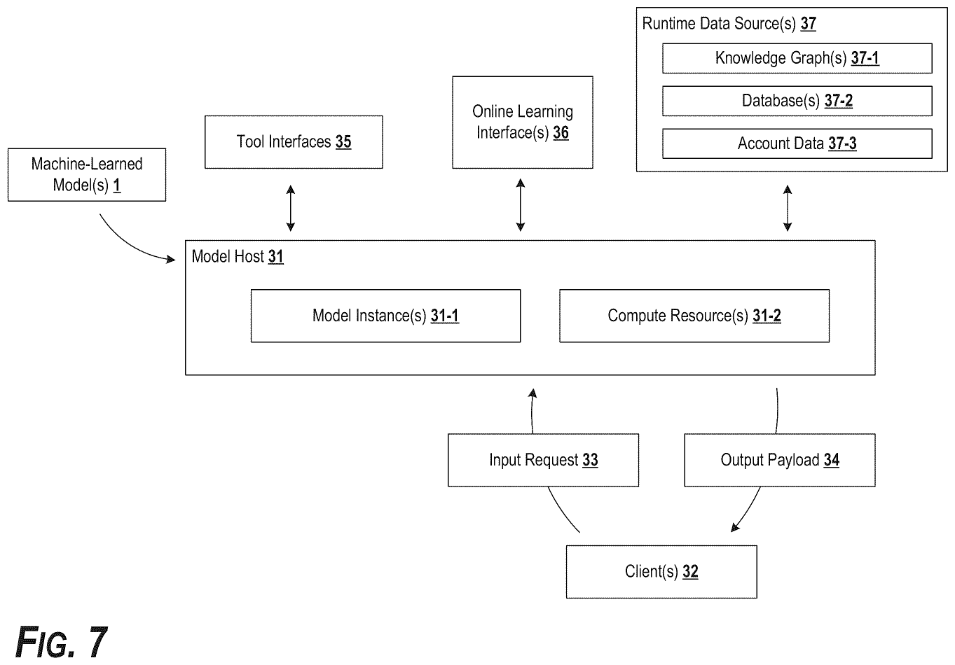

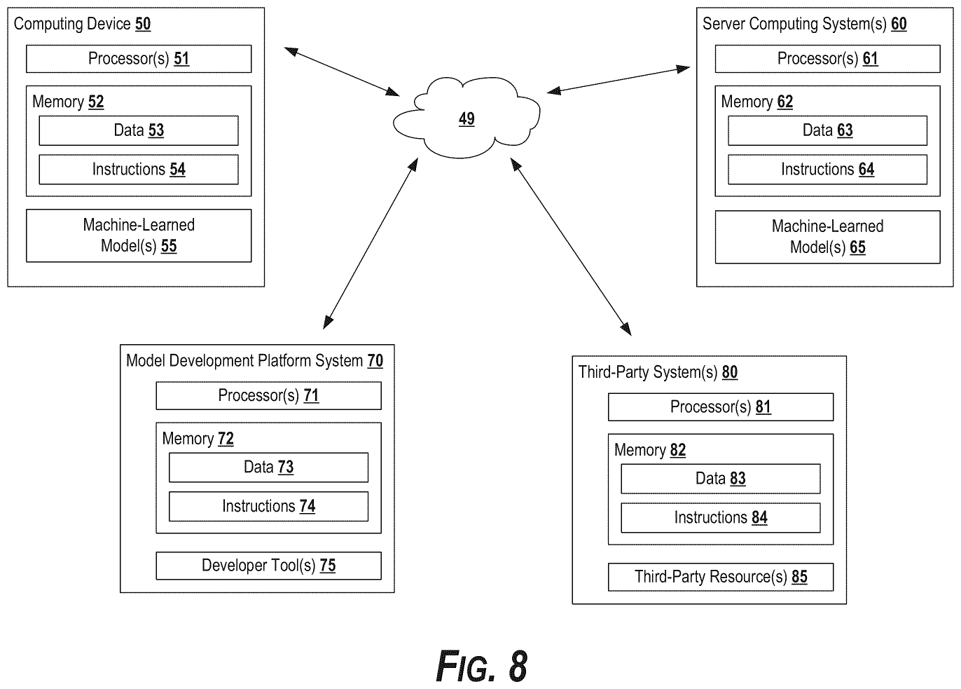

FIG. 8 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 8 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 8 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

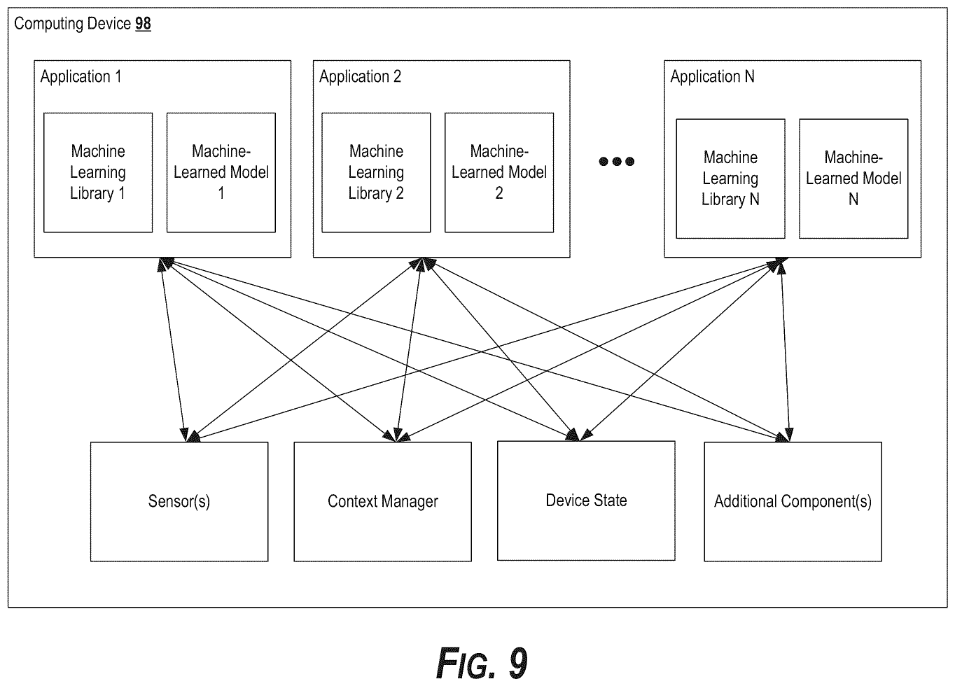

FIG. 9 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 9, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

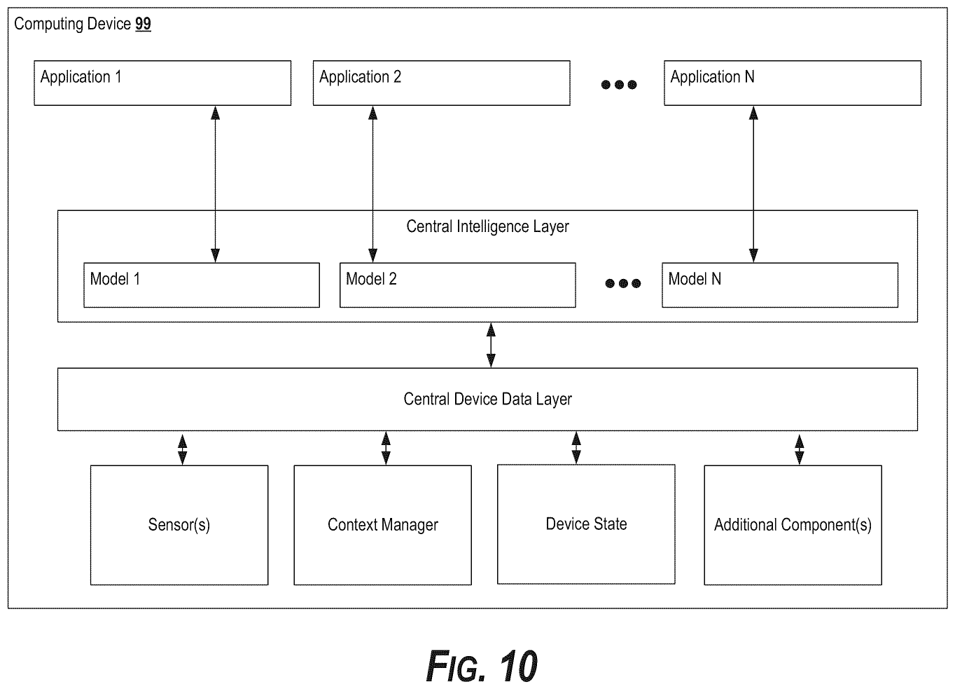

FIG. 10 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 10, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 10, the central device data layer can communicate with a number of other components of the computing device, such as, for example, one or more sensors, a context manager, a device state component, or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method to train a sequence processing model for use by a recommendation system, the method comprising:
obtaining, by a computing system comprising one or more computing devices, an item dataset that describes a plurality of items included in a candidate pool;
generating, by the computing system, a plurality of auxiliary prompts for use in training the sequence processing model, wherein each auxiliary prompt comprises a prompt input and a prompt output, and wherein the plurality of auxiliary prompts encode recommendation-related knowledge about the plurality of items;
training, by the computing system, the sequence processing model using the plurality of auxiliary prompts; and
providing, by the computing system, the trained sequence processing model for use in a recommendation system.

2. The computer-implemented method of claim 1, wherein the one or more auxiliary prompts comprise item embedding prompts that encode knowledge about the plurality of items.

3. The computer-implemented method of claim 2, wherein:
the item dataset describes, for each of the plurality of items, one or more attribute values for one or more item attributes; and
for at least one of the item embedding prompts: the prompt input identifies one of the plurality of items and the prompt output includes the attribute value for the identified item for at least one of the one or more attributes.

4. The computer-implemented method of claim 2, wherein:
the item dataset describes, for each of the plurality of items, one or more attribute values for one or more item attributes; and
for at least one of the item embedding prompts: the prompt input includes an attribute value for at least one of the one or more attributes and the prompt output identifies one or more of the items that have the provided attribute value.

5. The computer-implemented method of claim 2, wherein the one or more attributes comprise title, categories, brands, descriptions, or reviews.

6. The computer-implemented method of claim 5, wherein the item dataset specifies a plurality of users and historical interactions between each of the plurality of users and one or more of the plurality of items.

7. The computer-implemented method of claim 6, wherein the one or more auxiliary prompts comprise BPR loss reduction prompts that encode knowledge about the historical interactions of between the users and the items.

8. The computer-implemented method of claim 7, wherein, for at least one of the BPR loss reduction prompts:
the prompt input identifies a user, a positive item for the user, and a negative item for the user; and
the prompt output identifies the positive item.

9. The computer-implemented method of claim 6, wherein:
the one or more auxiliary prompts comprise masked item modeling prompts; and
for at least one of the masked item modeling prompts:
the prompt input contains a list of items that includes a masked item; and
the prompt output identifies an item that was masked to generate the masked item.

10. The computer-implemented method of claim 9, wherein generating the masked item modeling prompts comprises:
identifying, based on the item dataset, a sequence of items with which one of the plurality of users has interacted; and
masking one of the sequence of items with a masked item to generate the prompt input;
wherein the one of the sequence of items that is masked is a non-terminal item in the sequence of items.

11. The computer-implemented method of claim 10, wherein identifying, based on the item dataset, the sequence of items with which one of the plurality of users has interacted comprises applying a sliding window to extract the sequence of items.

12. The computer-implemented method of claim 1, wherein in some or all of the plurality of auxiliary prompts a user identifier for a user of the plurality of users is replaced with a sequence of items with which the user has interacted.

13. The computer-implemented method of claim 1, wherein in some or all of the plurality of auxiliary prompts an item identifier for an item of the plurality of items is replaced with a shortened identifier.

14. The computer-implemented method of claim 1, further comprising, after training, by the computing system, the sequence processing model using the plurality of auxiliary prompts but before providing, by the computing system, the trained sequence processing model for use in the recommendation system: training, by the computing system, the sequence processing model using one or more recommendation-task prompts.

15. The computer-implemented method of claim 1, wherein providing, by the computing system, the trained sequence processing model for use in the recommendation system comprises instructing, by the computing system, the trained sequence processing model to perform a retrieval task.

16. The computer-implemented method of claim 1, wherein providing, by the computing system, the trained sequence processing model for use in the recommendation system comprises instructing, by the computing system, the trained sequence processing model to perform a ranking task.

17. The computer-implemented method of claim 1, wherein providing, by the computing system, the trained sequence processing model for use in the recommendation system comprises instructing, by the computing system, the trained sequence processing model to perform a rating prediction task.

18. The computer-implemented method of claim 1, wherein the sequence processing model has not been previously trained on data specific to the candidate pool.

19. One or more non-transitory computer-readable media that collectively store a sequence processing model that has been trained by performance of training operations, the training operations comprising:
obtaining, by a computing system comprising one or more computing devices, an item dataset that describes a plurality of items included in a candidate pool;
generating, by the computing system, a plurality of auxiliary prompts for use in training the sequence processing model, wherein each auxiliary prompt comprises a prompt input and a prompt output, and wherein the plurality of auxiliary prompts encode recommendation-related knowledge about the plurality of items;
training, by the computing system, the sequence processing model using the plurality of auxiliary prompts; and
providing, by the computing system, the trained sequence processing model for use in a recommendation system.

20. A computer system comprising: one or more processors and one or more non-transitory computer-readable media that collectively store:
a sequence processing model that has been trained by performance of training operations, the training operations comprising:
obtaining, by a computing system comprising one or more computing devices, an item dataset that describes a plurality of items included in a candidate pool;
generating, by the computing system, a plurality of auxiliary prompts for use in training the sequence processing model, wherein each auxiliary prompt comprises a prompt input and a prompt output, and wherein the plurality of auxiliary prompts encode recommendation-related knowledge about the plurality of items;
training, by the computing system, the sequence processing model using the plurality of auxiliary prompts; and
providing, by the computing system, the trained sequence processing model for use in a recommendation system; and
computer-executable instructions for performing operations, the operations comprising:
receiving a query associated with a user;
generating a recommendation-task prompt based on the query;
processing the recommendation-task prompt with the sequence processing model to obtain a recommendation output that identifies one or more items; and
providing the one or more items as a recommendation output for the user.

21. The computer system of claim 20, wherein the computer system comprises a user computing device and the sequence processing model is implemented on-device on the user computing device.

22. The computer system of claim 20, wherein the computer system does not store an item dataset such that the recommendation output that identifies the one or more items is generated without accessing the item dataset.
